(19) United States
(12) Patent Application Publication
(10) Pub. No.: US 2017/0074010 A1
(43) Pub. Date: Mar. 16, 2017

(54) PUSH, PULL AND ROTATE DEADBOLT AND PASSAGE SET AND HELICAL GEAR MECHANISM THEREIN

(71) Applicant: BIG TOE INNOVATIONS INC., Surrey (CA)

(72) Inventor: James OLSON, Surrey (CA)

(21) Appl. No.: 15/267,038

(22) Filed: Sep. 15, 2016

Related U.S. Application Data
(60) Provisional application No. 62/219,168, filed on Sep. 16, 2015.

(51) Int. Cl. E05C 1/12; E05B 55/00; E05B 3/02; E05C 1/14; E05C 1/16; E05B 1/00; E05B 15/02

(52) U.S. Cl. CPC E05C 1/12; E05B 1/0053; E05B 55/005; E05B 15/0205; E05C 1/14; E05C 1/163; E05B 3/02

(57) ABSTRACT

A helical gear actuator for use with a passage set or deadbolt set is provided. The helical gear actuator comprises a shaft including an at least one helical groove, a plunger and a receiver including two tracks, the receiver shaped to rotatably accept the shaft, the groove shaped to slidably accept the two tracks, such that in use, urging the shaft into the receiver effects rotation of the receiver relative to the shaft. Also provided are the passage set and the deadbolt.

### CROSS REFERENCE TO RELATED APPLICATIONS

This application claims benefit of U.S. Provisional Application No. 62/219,168, filed Sep. 16, 2015, entitled PUSH, PULL AND ROTATE DEADBOLT AND PASSAGE SET AND HELICAL GEAR MECHANISM THEREIN, the contents of which is hereby incorporated in its entirety including all tables, figures and claims.

### FIELD OF THE INVENTION

The present technology includes a helical gear mechanism for use in a deadbolt and a passage set and the deadbolt and passage set. More specifically, it is an easy to operate push, pull and rotate mechanism and push, pull and rotate deadbolt and passage set.

### BACKGROUND OF THE DISCLOSURE

Opening and closing of doors can be difficult for many people, simply because the door closure mechanism is a door knob, or lever, both that need to be rotated. Whether the user is disabled, or has their hands full, these styles of openers are not very user friendly. To address this, numerous push-pull passage sets and some push pull door locks have been developed. These are often difficult to manufacture, have many moving parts that are subject to stress and wear and are still not as user friendly as they could be. For example, U.S. Pat. No. 6,139,072 discloses a push-pull door lock. The push-pull door lock comprises a lock case installed within an installation hole of a door. A slider is slidably mounted within the lock case. A latch bolt is connected to the slider through an elastic member. A push member is slidably mounted to a first side of the lock case and operably connected to the slider by a first intermediation assembly so as to slide the slider. A pull member is slidably mounted to a second side of the lock case and operably connected to the slider by a second intermediation assembly so as to slide the slider. The first intermediation assembly comprises a push plate, a first slide projection and a push rod. The second intermediation assembly comprises a pull plate, a second slide projection and a pull rod. The push and pull plates are rotatably mounted around a fixing pin. The first and second slide projections are formed on the slider and are respectively in contact with the push and pull plates. The push and pull rods are respectively formed on the ends of the push and pull members. This mechanism only allows for the push action to effect opening of the door from one side. Similarly, the pull action only functions on the other side of the door. This limits the effectiveness of the mechanism, only assisting a user to open and close the door on one side. Further, this is a complex system that is difficult to manufacture and subject to stress and wear when in use.

U.S. Pat. No. 6,293,598 discloses a push-pull door latch mechanism for latching/unlatching a retractable latch bolt of a latch bolt assembly. The latch mechanism includes a pair of handles, one on either side of a door, each handle having an engagement portion configured to engage a pin on a corresponding first and second rotatable cam. Each cam is provided with a latch bolt assembly engaging portion operably connected to the latch bolt assembly. The first cam further has a locking shoulder configured for selective engagement with a first lock member. A lock coupling operably connects the first lock member with a second lock member such that rotational movement of one of the first and second lock members causes rotational movement of the other of the first and second lock members. A lock knob provided on the interior side of the door is operably connected to the first lock member and facilitates toggling of the first and second lock members between the locked and unlocked positions. An override knob provided on the exterior side of the door is operably connected to the second lock member and facilitates toggling of the first and second lock members between the locked and unlocked positions. This is a complex system that is difficult to manufacture and subject to stress and wear when in use. The plane of linear movement of the handle causes an engagement portion of the handle to pivot about a pivot axis and engage a pin, which causes the cam to rotate about an axis normal to the plane of linear movement. Only one side is configured to be pushed and only the other side is configured to be pulled.

U.S. Pat. No. 5,029,916 discloses a push-pull door lock chiefly comprising a sleeve on one side of a conventional door lock and a sleeve with a pull ring on the front edge on another side thereof, wherein two rollers are pivotally mounted in the sleeve and two protruding shafts are provided to the end of sleeve, each one neck of the conventional door lock handle is provided with an inclined slide groove to receive each one roller on the sleeve, each one thimble is provided to each one fixing ring on both sides of the conventional door lock so as to respectively install a compression spring and a stretch spring and to receive the two protruding shafts on the sleeve; therefore, a push-press handle is on the one side of door lock and a pull-open handle is on the another side thereof, and through pushing the sleeve on the one side of the conventional door lock by any one portion of the user's body or pulling the pull ring on the front of sleeve on the another side thereof by his any one finger, the sleeve actuates the door lock handle to rotate, and the lock tongue is thus retracted inwards, so that the purpose of opening the door can be achieved. This lock does not permit a user from pushing the lock on both sides of the door in order to open the lock. This limits the effectiveness of the mechanism, only assisting a user to open and close the door on one side.

WO2014107048 discloses a push-pull door lock of which release can be carried out by a user by pushing a handle in a door-opening direction. The present invention pertains to a push-pull door lock, wherein a link body operates by the pushing of the handle member of a door lock main body such that the door lock is released so as to open a door. The link body includes a first link member and a second link member respectively provided to the upper end and the lower end of the handle member so as to rotate in one direction if the handle member is pressed; a connection bar for connecting and interlocking the first link member and the second link member; and a rack member provided to one end of the connection bar, which moves in a straight direction, so as to rotate a mortise rotation body. This lock does not permit a user from pushing the lock on both sides of the door in order to open the lock. This limits the effectiveness of the mechanism, only assisting a user to open and close the door on one side.

United States Patent Application 20140260458 discloses a push-pull door lock capable of selecting a lever work direction which may be installed without needing to coincide a door opening direction with the lever work direction by driving a driving unit during both a push operation and a pull operation of a lever coupled to each of housings of a front surface and a rear surface of a door to unlock a lock mechanism received in the door. The push-pull door lock includes: a lever that is provided on a front surface of each of housings, which are respectively coupled to an inside and an outside of a door by supports, to pivot in a front-and-back direction and has a protruding portion protruding toward a door; and a selection member that is provided on a rear surface of the housing and limits a pivoting range of the protruding portion in order to select a push operation or a pull operation of the lever. This system does not allow for push and pull functionality without specifically selecting one or the other. This adds complexity for the user, and requires dexterity.

What is needed is an easy to manufacture and easy to use mechanism for door locks and latches that provides them with push, pull and rotate functionality. The mechanism would preferably be adaptable for use in passage sets and deadbolts. What is further needed is a passage set that has push, pull and rotate functionality, using a split helical gear actuator. What is still further needed is a deadbolt that relies on a helical gear actuator and a cam mechanism disposed about an axis of rotation. The gearing system would have a minimum of moving parts, would have a minimum of movement and would therefore not be subject to undue wear.

### SUMMARY OF THE INVENTION

The present technology is a helical gear system for use in passage sets and deadbolts. The design has a minimum of moving parts and is easy to manufacture. The helical gear system provides push, pull and rotate functionality. For the passage set, a split helical gear system is used to allow the first and second sides of the passage set to operate independently. For the deadbolt, a single helical gear is used in conjunction with a cam mechanism disposed about an axis of rotation to provide the push, pull and rotate functionality.

In one embodiment, a helical gear actuator mechanism for use with a passage set or deadbolt set is provided, the helical gear actuator mechanism comprising a helical gear actuator and a receiver, the helical gear actuator including: a shaft, the shaft including an at least one helical groove extending along the shaft; a plunger, the plunger attached to a distal end of the shaft; and a housing, the housing moveably retaining the plunger, the receiver including two curved tracks extending into a receiver bore, the receiver bore rotatably retaining the shaft, and the groove slidably retaining the two tracks, such that in use, urging the shaft into the receiver with the plunger effects rotation of the receiver relative to the shaft.

In the helical gear actuator, the shaft may be a split shaft comprising a first and a second half shaft, each half shaft including a smooth surface, a step and an outer surface, the smooth surface of the first half shaft adjacent the smooth surface of the second half shaft, the step of the first half shaft abutting the step of the second half shaft and the outer surface of each half comprising half of the at least one helical groove.

In another embodiment, a passage set for use with a door is provided, the passage set comprising a first opener, a second opener, a first escutcheon plate, a second escutcheon plate, a first guide, a second guide, a first mounting plate, a cylinder, a first split helical gear actuator, a second helical gear actuator, a first plunger, a second plunger, a first housing, a second housing, and a latch assembly, the first opener moveably mounted in the first escutcheon plate, the second opener moveably mounted in the second escutcheon plate, the first and second guide housed in the first and second escutcheon plate, respectively, and attached to the first and second opener respectively, the first escutcheon plate mounted on the first mounting plate, the second escutcheon plate mounted on the cylinder, the first and the second split helical gear actuators each including: a split shaft, the split shaft including an at least one helical groove on an outer surface; the first plunger attached to a first end of the split shaft, the second plunger attached to a second end of the split shaft; and the first housing and the second housing moveably retaining the first plunger and the second plunger, respectively, the first and second housing slidably retained in the first and second guide, respectively, the latch assembly including a receiver, the receiver including two curved tracks on an inner surface of a bore, the receiver rotatably retaining the split shaft, the at least one helical groove of the split shaft slidably accepting the two tracks.

In the passage set, the split shaft may include a first split shaft and a second split shaft, the first split shaft and the second split shaft each including a half of the at least one helical groove, the split shafts abutting one another to form the split shaft and the at least one helical groove.

The passage set may be a push, pull and rotate passage set and the first and second opener each may include a first mating member, and the first and second plungers may each include a second mating member, each for mating with the first mating member on each of the first and second openers.

In the passage set, one mating member may be a female mating member, the female member defining a two, three, four or five sided shape and the other mating member may be a male mating member, the male mating member defining a three, four or five sided shape.

In the passage set, the female mating member may define a V-groove.

In the passage set, the second mating member may be a four sided polyhedron.

In the passage set, each first mating member may be the female mating member and each second mating member may be the male mating member, the first mating member pivotally mounted in a first and a second guide and in contact with the second mating member of the first and the second plunger, respectively.

In the passage set, the first and the second openers may be pivotally attached to the first and second guides, respectively.

In the passage set, each opener may be a lever.

In the passage set, the latch assembly may include a latch, the latch rotatably engaged with the receiver.

The passage set, may further comprise a striker plate, the striker plate comprising a latch aperture for accepting the latch, an at least one aperture for accepting an at least one screw, and a roller rotatably disposed in the latch aperture.

In the passage set, the roller of the striker plate may include a body and a pin, the body rotatably mounted on the pin.

In the passage set, the passage set may be a push and pull passage set and the first and second opener each include a first contact member and the first and second plungers each include a second contact member, the second contact members for contacting with the first contact members on the first and second openers.

In another embodiment, a set for use with a first and a second opener, a first and a second escutcheon plate, a mounting plate, a latch assembly and a cylinder is provided, the set comprising: a pair of first mating members; a first and second guide, each guide pivotally retaining one first mating members; a first plunger and a second plunger, the first and second plungers slidably retained in the first and second guide, respectively, the plungers each including a second mating member, the second mating member releasable mating with the first mating member; a first and a second split helical gear shaft each connected to one plunger, each split helical gear shaft including an at least one helical groove on an outer surface; and a receiver, the receiver including tracks in slidable engagement with the groove and rotatably retaining the first and second split helical gear shaft.

In the passage set, the split helical gear shaft may comprise a first and a second half shaft, each half shaft including a smooth surface, a step and an outer surface, the smooth surface of the first half shaft adjacent the smooth surface of the second half shaft, the step of the first half shaft abutting the step of the second half shaft and the outer surface of each half comprising half of the at least one helical groove.

In the passage set, the split helical gear shaft may comprise two helical grooves.

In yet another embodiment, a deadbolt for use with a latch assembly is provided, the deadbolt comprising: a helical gear actuator shaft, the helical gear actuator shaft including an at least one helical groove on at least a proximal section; a plunging guide, the plunging guide rotatably housing the helical gear actuator shaft and including guide blocks, a track engaging the helical groove and a plurality of teeth; a positioning guide, the positioning guide including a plurality of ridges, the plurality of ridges meshing with the plurality of teeth of the plunging guide; a cam body, the cam body rotatably housing the plunging guide and the positioning guide and including a series of cams, slots and grooves, the cams abutting the ridges, the slots and grooves slidably accepting the guide blocks, the slots slidably accepting the ridges; a drive shaft, the drive shaft in linear relation to the helical gear actuator shaft and attached to the helical gear actuator shaft at a helical gear actuator shaft distal end; a gate distal to the cam body and defining a port, the port for extension of the drive shaft therethrough; and a biasing member, the biasing member housed in the cam body and biasing the positioning guide.

In the deadbolt, the helical gear actuator shaft may include two helical grooves along a length of the shaft.

In the deadbolt, the drive shaft may include a bevel bearing and the gate includes a bearing guide.

The deadbolt may further comprise the latch assembly, the latch assembly including a latch, the latch in linear relation to the drive shaft and attached to the drive shaft at a drive shaft distal end.

### BRIEF DESCRIPTION OF THE DRAWINGS

FIGS. 1A, B, C, D and E show the helical gear actuator of the present technology. FIG. 1A is a single helical shaft; FIG. 1B is a double helical shaft; FIG. 1C shows the receiver for the shafts; FIG. 1D shows a split helical shaft; and FIG. 1D shows a cross section of on half of the split helical shaft.

FIG. 2A is an exploded side view and top view of a push, pull and rotate passage set of the present technology; FIG. 2B is an end view of an escutcheon plate; FIG. 2C is an end view of the guide; and FIG. 2D is an end view of a cylinder or mounting plate.

FIG. 3 is a side view of the passage set of the present technology.

FIG. 4A is an exploded view of the receiver and split shaft of the passage set; FIG. 4B is a detailed view of the helical gear actuator; FIG. 4C is an end view of the plunger; FIG. 4D is a detailed view of the receiver; and FIG. 4E is the receiver in the latch mechanism.

FIG. 5 is an alternative embodiment of the passage set of the present technology.

FIG. 6 is a push and pull passage set of the present technology.

FIG. 7 is an exploded side view of a deadbolt of the present technology.

FIG. 8A is a side view of the plunging guide of the deadbolt of FIG. 7; FIG. 8B is a cross sectional view of the plunging guide of the deadbolt of FIG. 7.

FIG. 9A is a side view of the helical gear actuator shaft and the driving shaft of the deadbolt; FIG. 9B is a top view of the clip of the deadbolt.

FIG. 10A is a side view of the positioning guide; FIG. 10B is a cross sectional view of the positioning guide of the deadbolt.

FIG. 11A is a side view of the cam body; FIG. 11B is a cross sectional view of the cam body of the deadbolt.

FIG. 12 is a side view of the gate of the deadbolt.

FIG. 13 is a side view of the deadbolt in the extended position.

FIG. 14 is a side view of the deadbolt in the compressed position.

FIG. 15 is a plan view of a striker plate of the present technology.

FIG. 16A is an exploded view of an alternative embodiment of the passage set; FIG. 16B is a cross section of the plug of the alternative embodiment of the passage set of the present technology.

### DETAILED DESCRIPTION OF THE EMBODIMENTS

Except as otherwise expressly provided, the following rules of interpretation apply to this specification (written description, claims and drawings): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, The terms “comprising,” “having,” “including,” and “containing” are to be construed as open ended terms (i.e., meaning “including, but not limited to,”) unless otherwise noted.

To the extent necessary to provide descriptive support, the subject matter and/or text of the appended claims is incorporated herein by reference in their entirety.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

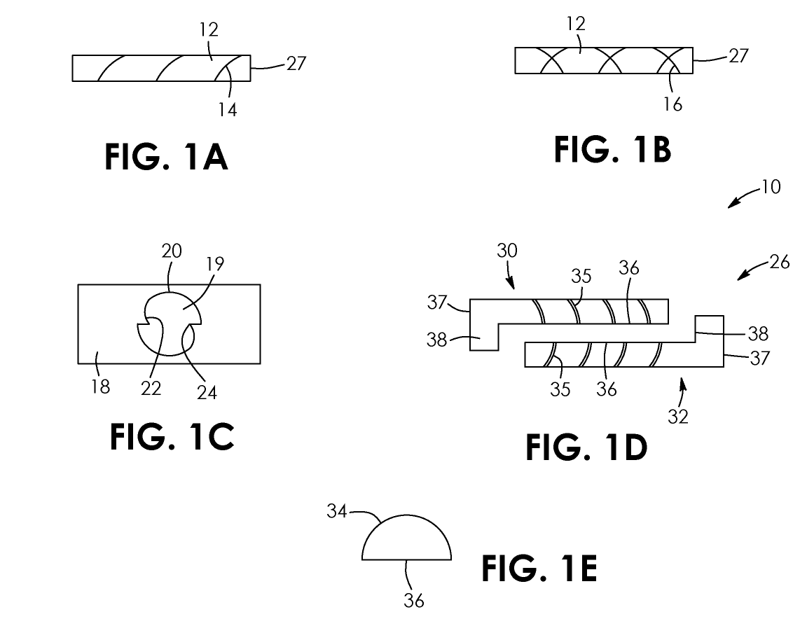

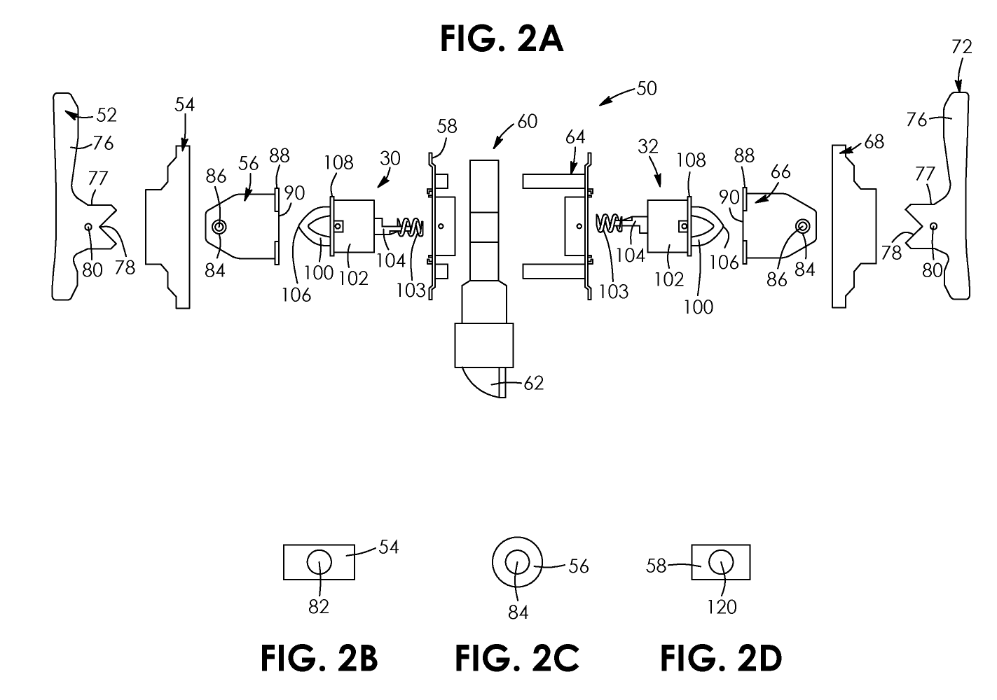

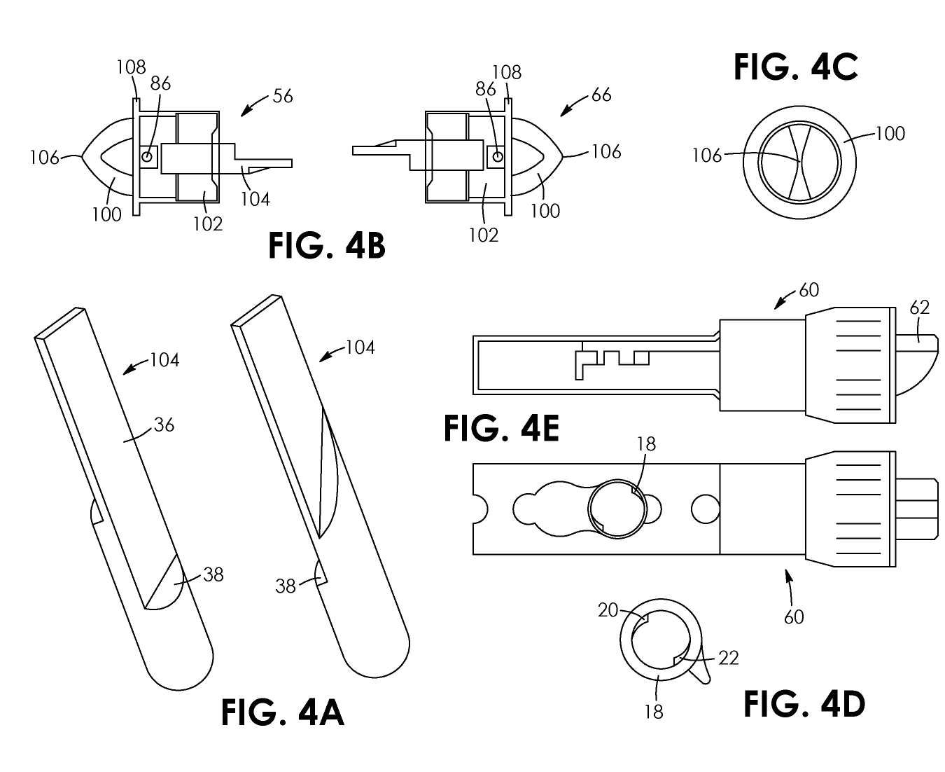

A helical gear actuator mechanism, generally referred to as 10 is shown in FIGS. 1A-1D. As shown in FIG. 1A, the gear actuator 10 has a shaft 12 with a helical groove 14, or as shown in FIG. 1B, a double helical groove 16 (there is at least one helical groove). The receiver 18 for the shaft 12 is shown in FIG. 1C. The receiver 18 is located in the latch mechanism (See FIG. 4E). The shaft 12 is sized to slidably fit in the receiver bore 19. A bore surface 20 of the receiver 18 has two curved tracks 22, 24 to slidably engage the helical groove 14 or the double helical groove 16. As shown in FIG. 1D, a split helical gear 26 has a first and a second split shaft, generally referred to as 30 and 32. Each half of the split helical gear 26 has outer side 34, which is a semi-circle (See FIG. 1E), with a helical groove 35 and an inner smooth side 36, with a proximal step 38 on the smooth side 36 at the proximal end 37. The split shaft 26 is sized to slidably fit in the receiver bore 19. The bore surface 20 has two curved tracks 22, 24 to slidably engage the helical groove 14 or the double helical groove 16 of the split shaft 26. A plunger 100 (See FIG. 2A) is attached to the distal end 27 of the shaft 12, 26 and is slidably housed in a housing 102 (See FIG. 2A).

FIG. 2A shows an exploded view of a passage set, generally referred to as 50. The passage set has a first and second split helical gear actuator 30, 32. Progressing from left to right, there is a first opener generally referred to as 52, which is preferably a lever, but may be a knob, a first escutcheon plate generally referred to as 54, a first guide generally referred to as 56, a first split helical gear actuator generally referred to as 30, a mounting plate generally referred to as 58, a latch assembly generally referred to as 60, with a latch 62, a cylinder generally referred to as 64, the second split helical gear actuator generally referred to as 32, a second guide generally referred to as 66, a second escutcheon plate generally referred to as 68 and a second opener generally referred to as 72, which is preferably a lever, but may be a knob.

The details of the passage set 50 components follow. The first opener 52 has a lever or knob end 76, an arm 77 defining a V-groove 78 and a V-groove aperture 80. The V-groove 78 is sized to slide in a bore 82 in the first escutcheon plate 54 (FIG. 2B). The guide aperture 84 and the V-groove aperture 80 align and are held in place with a pin 86 (FIG. 2C). The pin 86 allows for rocking of the V-groove 78 in the first guide 56. The first guide 56 has a rim 88 at a proximal end 90. The first split helical gear actuator 30 has a plunger 100, a housing 102 and a shaft 104. The plunger 100 has a four sided polyhedral head 106 that is shaped to mate with the V-groove 78. The plunger 100 is moveably housed in the housing 102. It is attached to the shaft 104 with the pin 86. A spring 103 biases the plunger 100 outward towards the first opener 52. The housing 102 has a stop 108 that abuts the rim 88 of the first guide 56. The shaft 104 has the half helical groove 35 on the outer surface 34 and the smooth flat inner surface 36 with the step 38 (again, there is at least one half helical groove) as shown in FIG. 1D. The housing 102 is housed in a bore 120 of the mounting plate 58 (FIG. 2D). The shaft 104 extends into the latch assembly 60.

The details of the components on the other side of the passage set 50 are identical to those of the first side of the passage set, with the exception that the mounting plate 58 is replaced with the cylinder 64. The second opener 72 has a lever or knob end 76, an arm 77 defining a V-groove 78 and a V-groove aperture 80. The V-groove 78 is sized to slide in a bore 82 in the second escutcheon plate 68 and a bore 83 in the second guide 66. The second guide 66 has a guide aperture 84. The guide aperture 84 and the V-groove aperture 80 align and are held in place with a pin 86. The pin 86 allows for rocking of the V-groove 78 in the second guide 66. The second guide 56 has a rim 88 at a proximal end 90. The second split helical gear actuator 32 has a plunger 100, a housing 102 and a shaft 104. The plunger 100 has a four sided polyhedral head 106 that is shaped to mate with the V-groove 78. It is attached to the shaft 100 with the pin 86. The plunger 100 is moveably housed in the housing 102. A spring 103 biases the plunger outward towards the second opener 72. The housing 102 has a stop 108 that abuts the rim 88 of the second guide 66. The shaft 104 has the helical groove 35 on the outer surface 34 and the smooth flat inner surface 36 with the step 38 as shown in FIG. 1D. The housing 102 is housed in the bore 122 of the cylinder 64. The shaft 104 extends into the latch assembly 60.

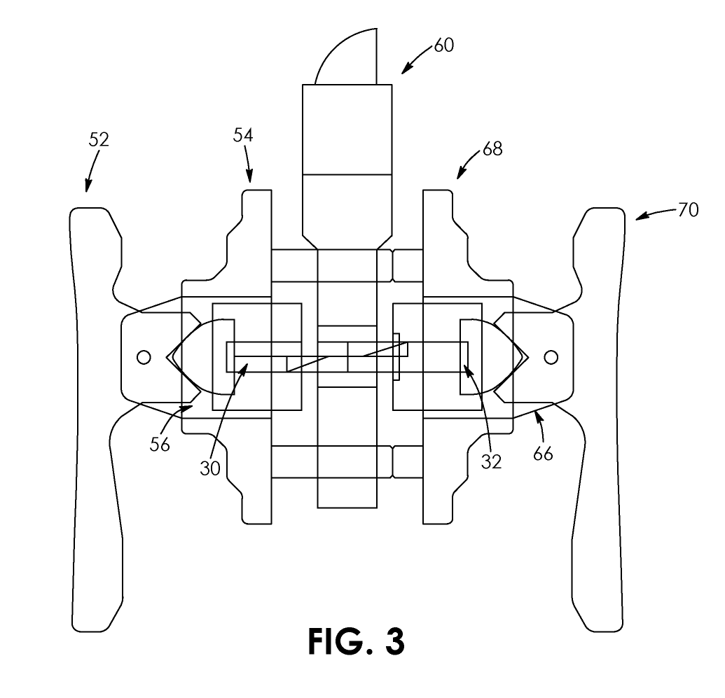

The assembled passage set is shown in FIG. 3.

As shown in FIG. 4A, the shafts 104 from each side of the passage set 50 align with each other with the smooth flat inner surfaces 36 of each shaft 104 abutting one another to form the split shaft 26. This split shaft 26 provides the at least one helical groove 12 or double helical groove 14 that slidably engage the two curved tracks 22, 24 of the receiver 18 in the latch assembly 60. Details of the helical gear actuator 56, 66 are shown in FIG. 4B and 4C. Details of the receiver 18 and the receiver 18 in the latch mechanism 60 are shown in FIGS. 4D and E.

Pushing or pulling on the lever 76 causes the latch 62 to withdraw from a striker plate in a door frame, allowing unlatching of the latch 62. The action and interaction of the components is identical whether the lever 76 is pushed or pulled and whether it is one side of the passage set or the other side. The lever 76 pivots about the pin 86 causing the V-groove 78 to urge the plunger 100 forward towards the latch assembly 60. This urges the shaft 104 into the receiver 18, causing the tracks 22, 24 of the receiver 18 to slide up the helical groove 12 or double helical groove 14 provided by the split shaft 26. The receiver 18 therefore rotates and, as occurs in a standard latch mechanism, causes the latch 62 to withdraw. As the plunger 100 on one side is being urged forward, the plunger 100 on the other side is being urged back into the housing 102 and the lever 76 to move in or out a small amount.

The lever 76 can also be rotated to unlatch the latch 62. Rotating the lever 76 causes the V-groove 78 again to urge the plunger 100 forward towards the latch assembly 60. However, it does not pivot about the pin 80. Instead, the faces of the polyhedral head 106 and the V-groove 78 catch on one another and as the V-groove rotates, it urges the polyhedral head 106 and therefore the plunger 100 towards the latch assembly 60. The remainder of the actions and interactions are the same as for when the lever 76 is pushed or pulled.

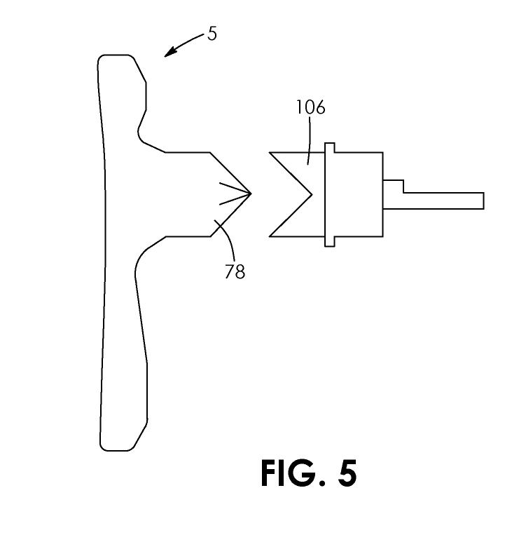

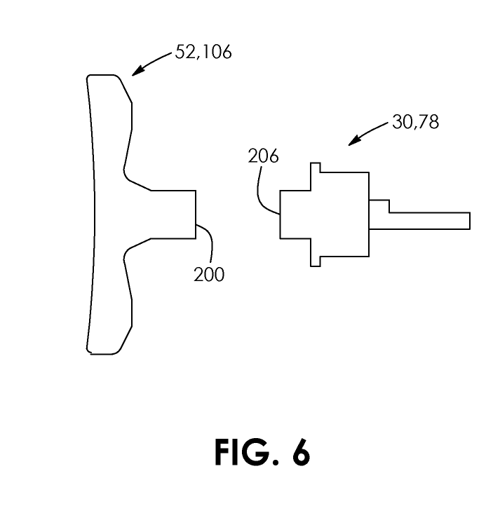

In the preferred embodiment a first mating member 78 and a second mating member 106 define the V-groove and the polyhedral head, respectively. In an alternative embodiment, as shown in FIG. 5, the first mating member is a male mating member and the second mating member is a female member. If only a push and pull mechanism is desired, mating of the members need only result in the second mating member being urged inward towards the latch mechanism. Hence, the mating members can be replaced with a first contact 200 and a second contact 202, as shown in FIG. 6. Without being bound to theory, edges, as provided, for example by the V-groove and the polyhedral head, provide the rotational capability. For this functionality, a two sided, three sided, four sided or five sided indent can interact with a head having three, four or five sides. The head may be a block or a polyhedron.

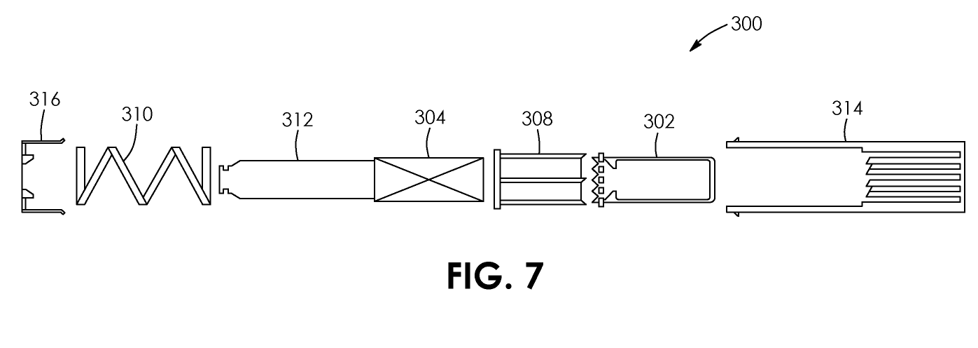

A deadbolt generally referred to as 300 is shown in FIG. 7. It has a plunging guide 302, a helical gear actuator shaft 304, a positioning guide 308, a spring 310, a drive shaft 312, a cam body 314 and a gate 316.

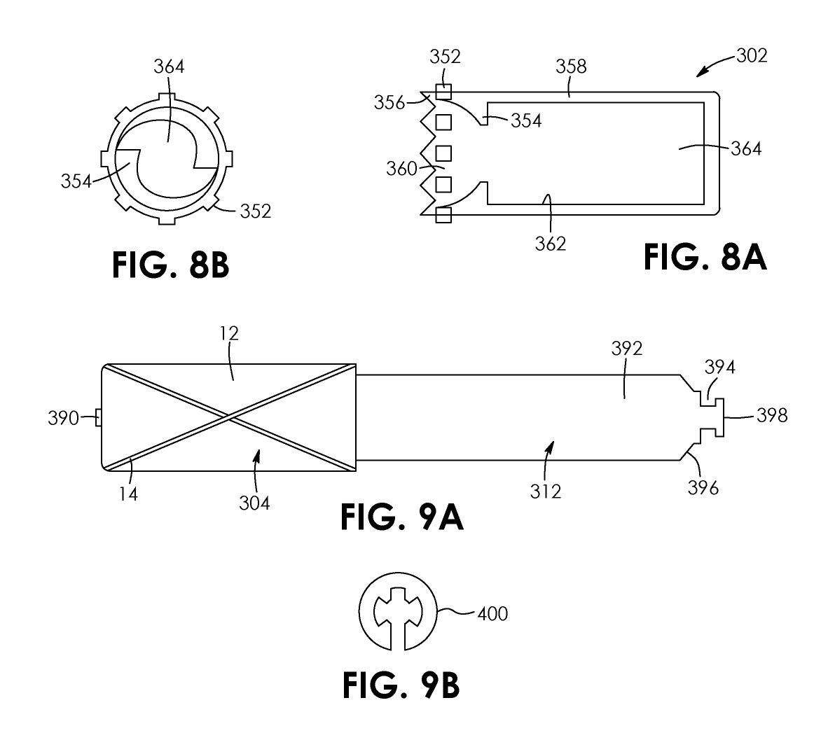

As shown in FIG. 8A and B, the plunging guide 302 has guide blocks 352, a track 354 and teeth 356 on an outer shell 358. The blocks 352 extend outward from the outer shell 358, the track 354 is located in a vicinity of a proximal end 360 on an inner surface 362 and the teeth 356 are at the proximal end 360. The outer shell 358 defines a bore 364. The plunging guide 302 provides the functionality of the plunger and receiver of the passage set, in addition to the other functions noted. The helical gear actuator shaft is equivalent to the shaft of the passage set.

The helical gear actuator shaft 304 has an at least one helical groove 14 or a double helical groove 16. The track 354 of the plunging guide 302 runs along the helical groove 16 of the shaft 304. When urged, the shaft 304 rotates along the helix and moves into the bore 364 of the plunging guide 302.

The drive shaft 312 is attached to the helical gear actuator shaft 304 with a bolt 390. It translates the forward and backward movement of the helical gear actuator shaft 304, hence the same functionality can be obtained by simply extending the length of the helical gear actuator shaft 304. If the helical gear actuator shaft is extended, the helical groove need only be in the proximal section. As shown in FIG. 9a, the drive shaft 312 has a shaft body 392, a hitch point 394, a bearing bevel 396, and an inner key housing 398. As shown in FIG. 9B, the hitch point 394 is used with a C-clip 400 to retain the drive shaft 312 in position in the gate 316. The bevel bearing 396 improves rotational stability. The inner key housing 398 allows for an extension of the moment of rotation by accepting a key 402. The drive shaft 312 is housed in the cam body 314 and gate 316. It rotates and moves forward and back with the helical gear actuator shaft 304.

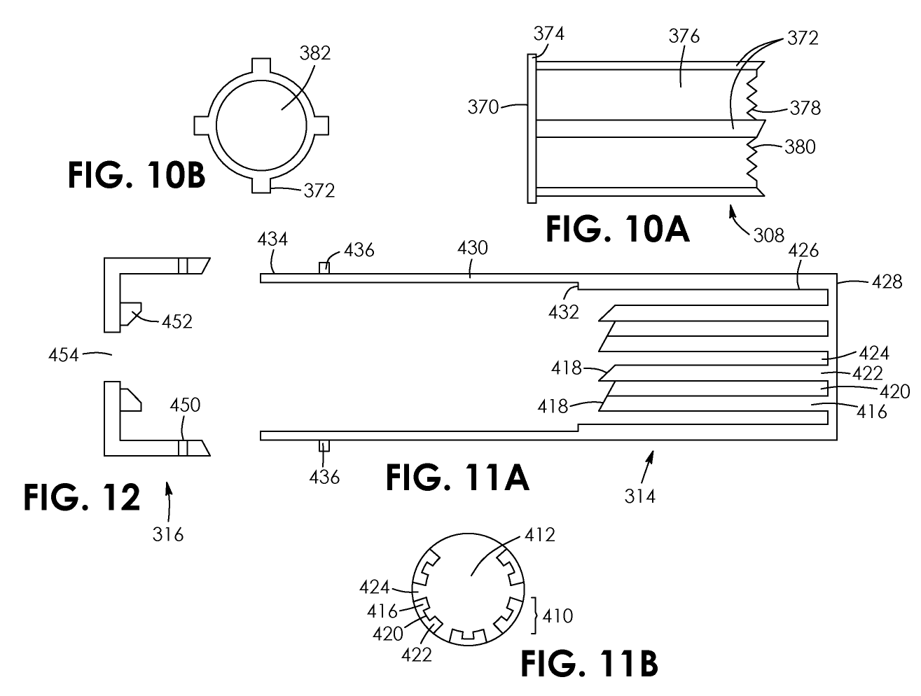

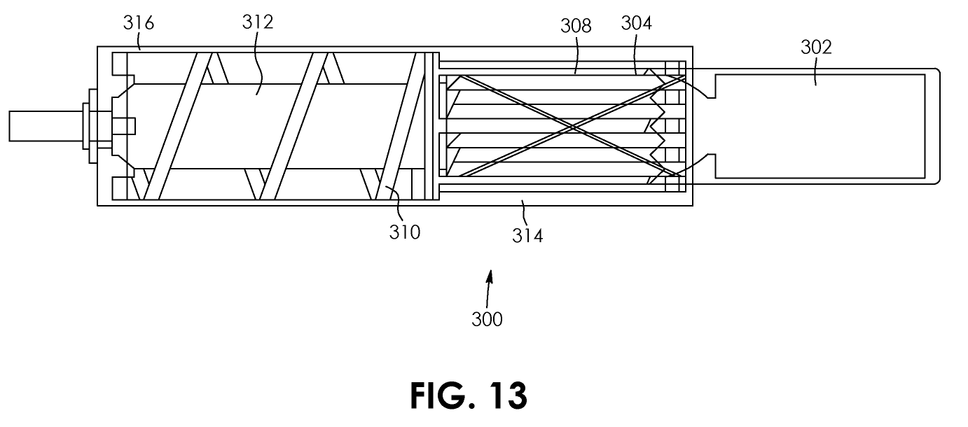

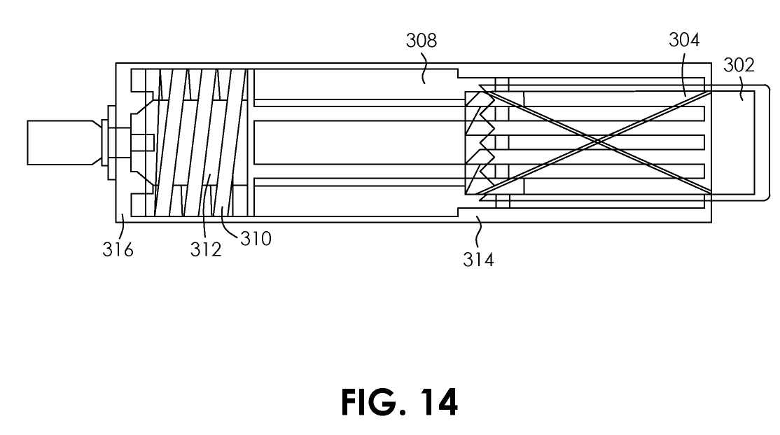

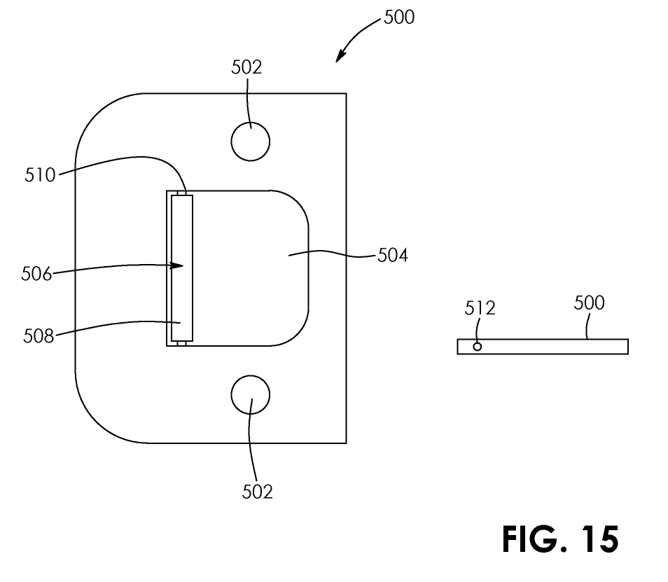

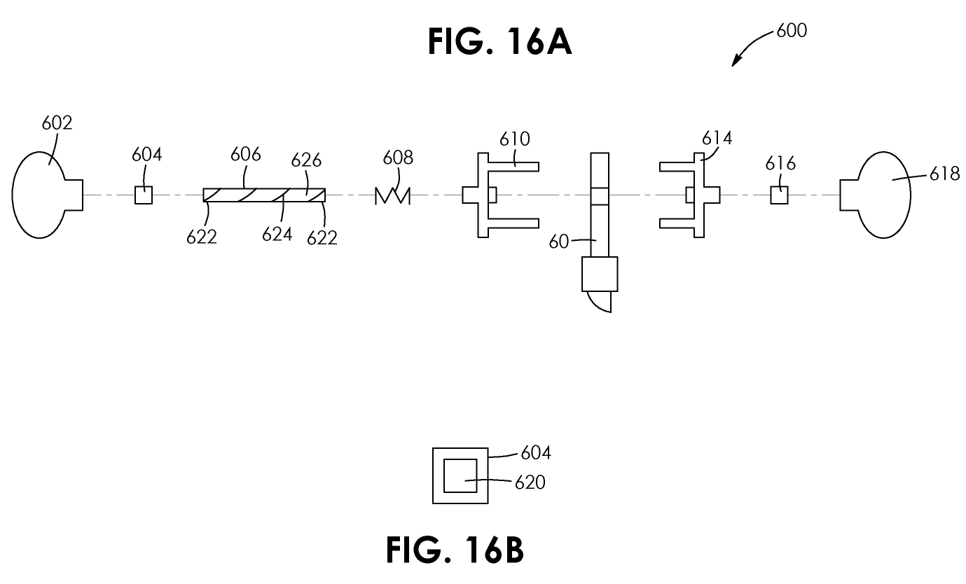

As shown in FIGS. 10A and B the positioning guide 308 has a load platform 370, a plurality of ridges 372, a lip 374, a body 376 and optional teeth 378 at a distal end 380. The positioning guide has a bore 382 therethrough. The optional teeth 378 can interdigitate with the teeth 356 of the plunging guide 302. The ridges 372 abut the blocks 352 of the plunging guide 302 and mesh with the teeth 356 of the plunging guide. The lip 374 stabilizes the positioning guide 308 as it rotates and moves forward and backwards in the cam body 314.

As shown in FIGS. 11A and 11B, the cam body 314 has a series of cams, generally referred to as 410 around a central bore 412. A first cam 416 has an angled top 418. Beside it is a groove 420 and then a taller second cam 422 again with an angled top 418. Beside this cam is a slot 424. A second series then starts, again with the first cam 416. The series continue around the inner surface 426 of the cam body 314 in a vicinity of the distal end 428. Proximal to this is a housing region 430 with a shoulder 432. The lip 374 of the positioning guide 308 sits on the shoulder 432 when in the first position. Proximate the proximal end 434 are pins 436 for retaining the gate 316.

As shown in FIG. 12, the gate 316 has a pin catch 450 that lock with pins 436, a bearing guide 452 for holding the drive shaft 312 in stable rotational motion and a port 454 for accessing the components. The gate may be integral with the cam body 314.

The spring 310 sits on the load platform 370 and extends to the proximal end of the gate 316. It is housed in the housing region 430 of the cam body 314 and is wound around the drive shaft 312.

In a first position, shown in FIG. 8, the cam body 314 houses the positioning guide 308. The ridges 372 of the positioning guide 308 are slidably located in the slots 424 and abut the guide blocks 352 of the plunging guide 302, which are also slidably located in the slot 424. As noted above, the teeth 356372 of the plunging guide 302 and the ridges 372 of the positioning guide 308 mesh. The spring 310 is extended. The guiding blocks 352 are in the slots 424 and the groove 420 of the cam body 314.

As it moves to a second position, as shown in FIG. 9, the plunging guide 302 slides over the helical gear actuator shaft 304. The track 354 of the plunging guide runs along the helical groove 16 of the helical gear actuator shaft 304, causing the helical gear actuator shaft 304 to rotate. As it is attached to the drive shaft 312, the drive shaft 312 also rotates. Concomitantly, the positioning guide 308 is urged forward by the blocks 352 and the teeth 356 of the plunging guide 302. As the positioning guide 308 moves forward, it compresses the spring 310. The positioning guide 308 moves into the housing region 430 of the cam body 314. This removes the ridges 372 from the slots 424.

Once in the second position, the blocks 352 of the plunging guide 302 are also removed from the slots 424 and the grooves 420. The ridges 372 sit on the angled top 418 of the first cam 416 and is held in place by the taller second cam 422. Further forward movement of the plunging guide 302 causes the ridges 372 to move up over the angled top 418 of the second cam 422. This causes both the blocks 352 to re-enter the slots 424 and grooves 420 and for the ridges 372 to re-enter the slots 424, returning to the first position. The plunging guide 302 and the positioning guide 308 have moved from one slot to the next and are positioned to repeat the process, proceeding around the cam body 314.

A latch assembly 450 is fitted around the drive shaft 312 that extends outside of the gate 316. As the drive shaft 312 is rotated, the latch 452 extends from the assembly 450 and is retracted into the assembly 450, locking and unlocking the door. The latch 452 is attached to a distal end 454 of the drive shaft 312 and is in linear relation with the drive shaft 312.

The preferred striker plate, generally referred to as 500, is shown in FIG. 10. It has two apertures 502 for accepting screws, a latch aperture 504 for releasably retaining a latch 62, 452 and a roller, generally referred to as 506. The roller includes a body 508 and a pin 510 that allows the body 508 to roll freely. The pin 510 is mounted in small pin apertures 512 in the striker plate 500.

In an alternative embodiment, shown in FIG. 11, a passage set, generally referred to as 600 has a first knob 602, a first plug 604, a helical gear actuator shaft 606, a spring 608, which can be any biasing member, a first mounting plate 610, a latch assembly generally referred to as 60, a second mounting plate 614, a second plug 616 and a second knob 618. The first and second plugs 604, 616, fit into the door knobs 602, 618 and hold the helical gear actuator shaft 606 in a shaft aperture 620. The ends 622 of the helical gear actuator shaft 606 are shaped to mate with the plugs 604, 616. The shaft 606 has a helical groove 624 on the outer surface 626 that slidably engages the two curved tracks 22, 24 of the receiver 18 in the latch assembly 60 (as shown in FIG. 1C and FIG. 3 [noting that there is a shaft 606 in this embodiment, rather than the split shaft shown in FIG. 3].

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize, or be able to ascertain using no more than routine experimentation, many equivalents to the specific example embodiments specifically described herein. Such equivalents are intended to be encompassed in the scope of the claims, if appended hereto or subsequently filed.

What is claimed is:

1. A helical gear actuator mechanism for use with a passage set or deadbolt set, the helical gear actuator mechanism comprising a helical gear actuator and a receiver, the helical gear actuator including: a shaft, the shaft including an at least one helical groove extending along the shaft; a plunger, the plunger attached to a distal end of the shaft; and a housing, the housing moveably retaining the plunger, the receiver including two curved tracks extending into a receiver bore, the receiver bore rotatably retaining the shaft, and the groove slidably retaining the two tracks, such that in use, urging the shaft into the receiver with the plunger effects rotation of the receiver relative to the shaft.

2. The helical gear actuator of claim 1, wherein the shaft is a split shaft comprising a first and a second half shaft, each half shaft including a smooth surface, a step and an outer surface, the smooth surface of the first half shaft adjacent the smooth surface of the second half shaft, the step of the first half shaft abutting the step of the second half shaft and the outer surface of each half comprising half of the at least one helical groove.

3. A passage set for use with a door, the passage set comprising a first opener, a second opener, a first escutcheon plate, a second escutcheon plate, a first guide, a second guide, a first mounting plate, a cylinder, a first split helical gear actuator, a second helical gear actuator, a first plunger, a second plunger, a first housing, a second housing, and a latch assembly, the first opener moveably mounted in the first escutcheon plate, the second opener moveably mounted in the second escutcheon plate, the first and second guide housed in the first and second escutcheon plate, respectively, and attached to the first and second opener respectively, the first escutcheon plate mounted on the first mounting plate, the second escutcheon plate mounted on the cylinder, the first and the second split helical gear actuators each including: a split shaft, the split shaft including an at least one helical groove on an outer surface; the first plunger attached to a first end of the split shaft, the second plunger attached to a second end of the split shaft; and the first housing and the second housing moveably retaining the first plunger and the second plunger, respectively, the first and second housing slidably retained in the first and second guide, respectively, the latch assembly including a receiver, the receiver including two curved tracks on an inner surface of a bore, the receiver rotatably retaining the split shaft, the at least one helical groove of the split shaft slidably accepting the two tracks.

4. The passage set of claim 3, wherein the split shaft includes a first split shaft and a second split shaft, the first split shaft and the second split shaft each including a half of the at least one helical groove, the split shafts abutting one another to form the split shaft and the at least one helical groove.

5. The passage set of claim 4, wherein the passage set is a push, pull and rotate passage set and the first and second opener each include a first mating member, and the first and second plungers each include a second mating member, each for mating with the first mating member on each of the first and second openers.

6. The passage set of claim 5, wherein one mating member is a female mating member, the female member defining a two, three, four or five sided shape and the other mating member is a male mating member, the male mating member defining a three, four or five sided shape.

7. The passage set of claim 6, wherein the female mating member defines a V-groove.

8. The passage set of claim 7, wherein the second mating member is a four sided polyhedron.

9. The passage set of claim 8, wherein each first mating member is the female mating member and each second mating member is the male mating member, the first mating member pivotally mounted in a first and a second guide and in contact with the second mating member of the first and the second plunger, respectively.

10. The passage set of claim 9, wherein the first and the second openers are pivotally attached to the first and second guides, respectively.

11. The passage set of claim 10, wherein each opener is a lever.

12. The passage set of claim 11, wherein the latch assembly includes a latch, the latch rotatably engaged with the receiver.

13. The passage set of claim 12, further comprising a striker plate, the striker plate comprising a latch aperture for accepting the latch, an at least one aperture for accepting an at least one screw, and a roller rotatably disposed in the latch aperture.

14. The passage set of claim 13, wherein the roller of the striker plate includes a body and a pin, the body rotatably mounted on the pin.

15. The passage set of claim 4, wherein the passage set is a push and pull passage set and the first and second opener each include a first contact member and the first and second plungers each include a second contact member, the second contact members for contacting with the first contact members on the first and second openers.

16. A set for use with a first and a second opener, a first and a second escutcheon plate, a mounting plate, a latch assembly and a cylinder, the set comprising: a pair of first mating members; a first and second guide, each guide pivotally retaining one first mating members; a first plunger and a second plunger, the first and second plungers slidably retained in the first and second guide, respectively, the plungers each including a second mating member, the second mating member releasable mating with the first mating member; a first and a second split helical gear shaft each connected to one plunger, each split helical gear shaft including an at least one helical groove on an outer surface; and a receiver, the receiver including tracks in slidable engagement with the groove and rotatably retaining the first and second split helical gear shaft.

17. The set of claim 16, wherein the split helical gear shaft comprises a first and a second half shaft, each half shaft including a smooth surface, a step and an outer surface, the smooth surface of the first half shaft adjacent the smooth surface of the second half shaft, the step of the first half shaft abutting the step of the second half shaft and the outer surface of each half comprising half of the at least one helical groove.

18. The set of claim 17, wherein the split helical gear shaft comprises two helical grooves.

19. A deadbolt for use with a latch assembly, the deadbolt comprising: a helical gear actuator shaft, the helical gear actuator shaft including an at least one helical groove on at least a proximal section; a plunging guide, the plunging guide rotatably housing the helical gear actuator shaft and including guide blocks, a track engaging the helical groove and a plurality of teeth; a positioning guide, the positioning guide including a plurality of ridges, the plurality of ridges meshing with the plurality of teeth of the plunging guide; a cam body, the cam body rotatably housing the plunging guide and the positioning guide and including a series of cams, slots and grooves, the cams abutting the ridges, the slots and grooves slidably accepting the guide blocks, the slots slidably accepting the ridges; a drive shaft, the drive shaft in linear relation to the helical gear actuator shaft and attached to the helical gear actuator shaft at a helical gear actuator shaft distal end; a gate distal to the cam body and defining a port, the port for extension of the drive shaft therethrough; and a biasing member, the biasing member housed in the cam body and biasing the positioning guide.

20. The deadbolt of claim 19, wherein the helical gear actuator shaft includes two helical grooves along a length of the shaft.

21. The deadbolt of claim 20, wherein the drive shaft includes a bevel bearing and the gate includes a bearing guide.

22. The deadbolt of claim 21, further comprising the latch assembly, the latch assembly including a latch, the latch in linear relation to the drive shaft and attached to the drive shaft at a drive shaft distal end.
